(19) United States
(12) Patent Application Publication
(10) Pub. No.: US 2013/0037503 A1
(43) Pub. Date: Feb. 14, 2013

(54) Rotating Storage Tree

(71) Applicants: Gary Cimino, Norwalk, CT (US); Lauren N. Cimino, Norwalk, CT (US)

(72) Inventors: Gary Cimino, Norwalk, CT (US); Lauren N. Cimino, Norwalk, CT (US)

(21) Appl. No.: 13/572,117

(22) Filed: Aug. 10, 2012

Related U.S. Application Data
(60) Provisional application No. 61/522,962, filed on Aug. 12, 2011.

(51) Int. Cl. A47B 49/00; B23P 17/04; A47B 81/00

(52) U.S. Cl. 211/85.3; 211/163; 29/428

(57) ABSTRACT

A storage rack and means for a storage rack for easily and conveniently supporting and storing various items, such as footwear, boots and/or handbags. A method for manufacturing a storage rack that supports and stores various items, such as footwear, boots and/or handbags

### CROSS-REFERENCE TO RELATED APPLICATIONS

The present application claims the benefit under 35 U.S.C. §119 (e) of the Provisional Patent Application Ser. No. 61/522,962 filed Aug. 12, 2011. The contents of Provisional Patent Application Ser. No. 61/522,962 filed Aug. 12, 2011 are hereby incorporated by reference in its entirety.

### FIELD OF THE INVENTION

A storage rack and means for a storage rack for easily and conveniently supporting and storing various items, such as footwear, boots and/or handbags. The storage rack rotates to allow access to the various items supported by the rack.

### BACKGROUND OF THE INVENTION

The use of a means for supporting and storing footwear is known in the prior art. Known prior art for storing footwear includes U.S. Pat. No. 6,308,838 to Endean; U.S. Pat. No. 5,065,871 to Chan; U.S. Pat. No. 4,889,246 to Lee; U.S. Pat. No. 4,688,685 to Brace; U.S. Pat. No. 3,874,512 to Wegley et al.; U.S. Pat. No. 3,472,389 to Lowe; U.S. Pat. No. 3,161,294 to Meuche; U.S. Pat. No. 1,928,292 to Lazarus; U.S. Pat. No. 1,089,290 to Thompson; U.S. Pat. No. 1,038,198 Randall et al.; U.S. Pat. No. 891,029 Beach; U.S. Pat. No. 764,343 Bowen; U.S. Pat. No. 346,293 Lavaggi; and U.S. Pat. No. D326,573 Crawford et al.

While these references fulfill their respective, particular objectives and requirements, the aforementioned patents do not disclose a rack having a circular base member, a longitudinal member extending from the base and support rods (pegs) extending from the longitudinal support member, where the pegs project around the longitudinal member forming a tree structure, so that footwear such as boots and/or handbags are easily and conveniently supported and stored.

These prior art devices also do not provide a rotatable base member allowing rotation infinitely in either direction.

Such a device is novel and unobvious over the prior art and providing such a device is an object of this application. Existing devices have not recognized the advantages of providing a storage rack with a rotatable base that is circular. This allows for increased access to the footwear and the ability to place the device in a corner of a closet whereby the device can be rotated for easy access to various footwear or handbags that may be supported by the support pegs on the storage rack.

Furthermore having a storage rack with a rectangular (or square) longitudinal member allows for an increasing number of sockets to be located on the longitudinal member, such that increased number of pegs may be fixed within the sockets allowing for increased flexibility and adjustment of the pegs based on the size and height of various items to be placed on the storage rack.

In these respects, the storage rack according to the present invention substantially departs from the conventional concepts and designs of the prior art, and in so doing provides an apparatus primarily developed for the purpose of easily and conveniently supporting and storing footwear, boots and/or handbags.

It is thus desirable to provide a storage rack providing these advantages.

### SUMMARY OF THE INVENTION

It is an object of the present invention to provide a storage rack which has means for easily and conveniently supporting and storing footwear and/or handbags. It is another object of the present invention to provide a storage rack which is of a durable and reliable construction.

It is another object of the present invention to provide a storage rack which is susceptible of a low cost of manufacture with regard to both materials and labor, and which accordingly is then susceptible of low prices of sale to the consuming public, thereby making such a storage rack economically available to the buying public.

It is another object of the present invention is to provide a storage rack that allows the user to neatly arrange and store footwear and/or handbags and allow for footwear and/or handbags to be easily accessible to a user.

These and other objectives are achieved by providing a storage rack comprising: a rotatable base; a longitudinal member extending upwardly from the base, the longitudinal member being substantially perpendicular to the base and having a plurality of sockets, and a plurality of support pegs, the plurality of support pegs fitting within the plurality of sockets. The support pegs may also be referred to as dowels.

The base may comprise an upper base element and lower base element, the upper base element being rotatable or rotating around the lower base element. The base may be configured as a lazy-Susan rotating type mechanism. The base may be round, circular, square or any such geometric or non-geometric shape. In certain embodiments, the base may be weighted and may be made of heavy materials (such as lead or other types of heavy metal) to prevent the storage rack from tipping over once footwear is placed on the storage rack.

The longitudinal member may be rectangular and may have four sides. In certain embodiments, the longitudinal member may be square, such that each side is equal. In certain embodiments, the longitudinal member may be round, square, rectangular, or any geometric or non-geometric shape. In certain embodiments, the longitudinal member may be made out of wood, metal or a combination thereof. The longitudinal member may also have a cylindrical shape.

The longitudinal member may be removable from the base and may be securely mounted to a top of said base.

The storage rack may further comprise at least one support element for securing the longitudinal member to the base. In certain embodiments, the at least one support element may have a concave shape, and may have two surfaces, one of the surfaces abutting against the longitudinal member and the other surface abutting against the base. In certain embodiments, at least one fastening device may be used to secure the support element to the base and to the longitudinal member. In certain embodiments, the at least one fastening device may be a screw, nail or other such fastening device known in the art.

The plurality of support pegs used in the storage rack may be of variable length. The longitudinal member may be of variable length and may be adjustable. The longitudinal member may have an additional internal longitudinal member that may extend past the top of the longitudinal member, so that the storage rack can have an increased vertical height.

The plurality of sockets in the longitudinal member may be located on each of the four sides of the rectangular longitudinal member. This allows the plurality of sockets to be arranged extending perpendicular to one another.

The plurality of sockets in the longitudinal member may extend radially outward from the longitudinal member. The plurality of sockets may be located in a staggered pattern over the longitudinal member. This allows the sockets to be arranged to accommodate items of various sizes.

The rotatable base may rotate 360 degrees and may allow for the longitudinal member to rotate 360 degrees.

The plurality of support pegs may support footwear, handbags, hats and other various items.

The storage rack may further comprise at least one clip and at least one hanger, the at least one clip attached to at least one of the plurality of support pegs, wherein the at least one clip attaches to the at least one hanger for supporting an item. The clip may have V-shape and the hanger may have a C-shape in certain embodiments.

The at least one clip and at least one hanger may allow for items to be hanged further away from the support pegs. This also may allow for more than one item to be placed on an individual support peg. The clip may have a spring within the clip, so that the clip can tightly attach onto an individual support peg.

Items supported by the at least one clip and at least one hanger may be at least one of footwear, handbags, or hats.

In certain embodiments, the longitudinal member of the storage rack may be hollow. The longitudinal member may further comprise a cap covering the top of the longitudinal member.

Other objectives of the present invention are achieved by providing a method of manufacturing a storage rack, the method comprising the steps of: providing a rotatable base; providing a longitudinal member having a plurality of sockets; providing at least one support element; attaching the longitudinal member to the top of the base; attaching the at least one support member to the top of the base and to the longitudinal member so that the longitudinal member is substantially perpendicular to the base and extends upwardly from the base; and providing a plurality of support pegs.

In certain embodiments, the method further comprises inserting the plurality of support pegs into the plurality of sockets.

The longitudinal member may be rectangular and may have four sides. In certain embodiments, the longitudinal member may be square. In other embodiments, the longitudinal member may be round, rectangular, or any geometric or non-geometric shape. In certain embodiments, the longitudinal member may have a cylindrical shape.

The base may comprise an upper base element and lower base element, the upper base element being rotatable around the lower base element.

In some embodiments, the base may be circular and may be in the form of a “lazy-Susan” turntable. In other embodiments, the base may be square, round, rectangular, or any geometric or non-geometric shape.

Other objectives of the present invention are achieved by providing a storage rack comprising a base means, a “lazy-Susan” type turntable capable of infinite rotation in either direction, a square central shaft, and footwear support members being essentially dowels or pegs which can be inserted into a plurality of holes bored into the central shaft on all four sides, and boot clips which provide a means of clamping onto the boots, and hanging them on the pegs.

In other embodiments of the invention, the invention generally comprises a base means with a “lazy-Susan” type ball bearing swivel, capable of rotating infinitely in either direction, a square central support member having a series of holes on all 4 sides, which allows the owner to place the supplied pegs/supports in a location appropriate to the length of the boots to be supported, and a boot clip, which clamps on the boots, and hangs on the pegs.

In certain embodiments, the holes may be located in a random pattern to allow for various items of different sizes.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

The invention is not limited in its application to the details of construction and to the arrangements of the components set forth in the following description or illustrated in the drawings. The invention is capable of other embodiments and of being practice and carried out in various ways. Also, it is to be understood the phraseology and terminology employed herein are for the purpose of description and should not be regarded as limiting.

### BRIEF DESCRIPTION OF THE DRAWINGS

FIG. 1 is an exploded perspective view of a storage rack according to the present invention;

FIG. 2 is a side elevation view of FIG. 1 as assembled;

FIG. 3 is a top plan view of FIG. 1;

FIG. 4 is a perspective view of a clamp/hanger used with FIG. 1;

and

FIG. 5 is a side view of the clamp/hanger of FIG. 4.

### DETAILED DESCRIPTION OF THE INVENTION

The invention will be better understood and objects other than those set forth above will become apparent when consideration is given to the following detailed description thereof. Such description makes reference to the annexed drawings.

With reference now to the drawings, a new footwear storage rack 1000 embodying the principles and concepts of the present invention will be described.

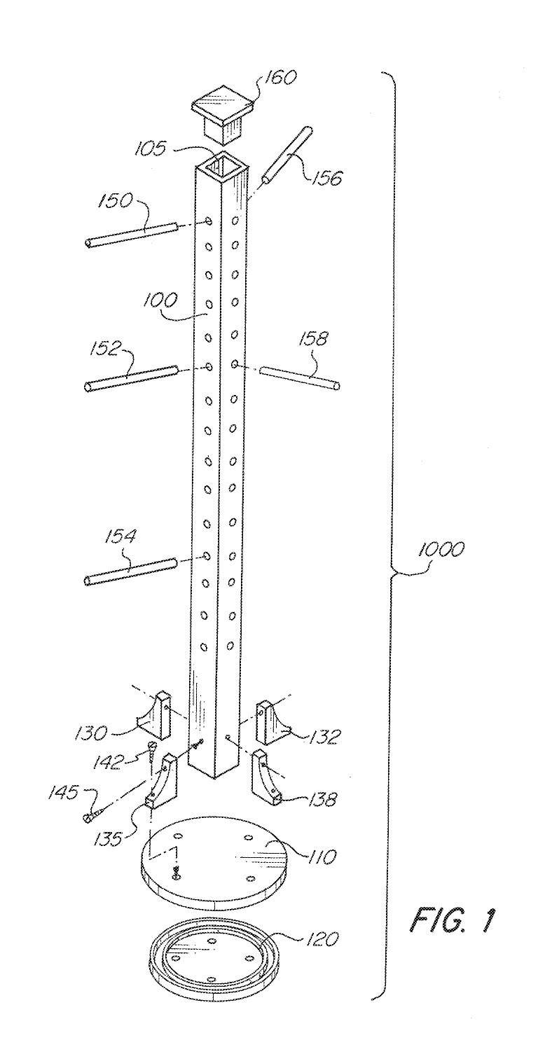

As best illustrated, FIGS. 1 through 3 show a storage rack 1000 that comprises a base member 110/120 including a round or circular base member 110 (also referred to as an upper base member) secured to a lazy-Susan type device 120 (also referred to as a lower base member), and a longitudinal member 100 being securely mounted with support elements 130, 132, 135, 138 (curved brackets) to the base member 110. Shown in FIG. 1 are screws 142, 145 that secure the support elements 130, 132, 135, 138 to the base member 110 and to the longitudinal member 100. However, other attachment members may be used in other embodiments.

The longitudinal member 100 is shown having a plurality of sockets (holes) therein for supporting footwear pegs/dowels, which are adjustable, meaning they can be placed into any hole, depending on the height of the boots, footwear, or hand bags. The length of the pegs/dowels can be adjustable. In certain embodiments, the pegs/dowels have a ½ diameter and are adjustable to fit within various sockets in the longitudinal member.

In use, footwear such boots and/or hand bags may be stored and supported by the footwear storage rack by the user hooking the pair of boots attached to the boot clip/hanger onto one of the pegs/dowels. The boots are essentially suspended from the footwear storage rack which may include a plurality of locations, depending on the height of the boots, footwear, and/or handbag.

FIG. 1 provides an exploded view of an embodiment of the invention. FIG. 1 shows longitudinal member 100 having a cap 160. The longitudinal member 100 is supported by support elements 130/132/135/138, one on each side of the longitudinal member. Furthermore, FIG. 1 shows the base being in two parts, where the upper base member 110 is supported by lower base member 120. Upper base member 110 can rotate on top of lower base member in a Lazy-Susan type rotational arrangement.

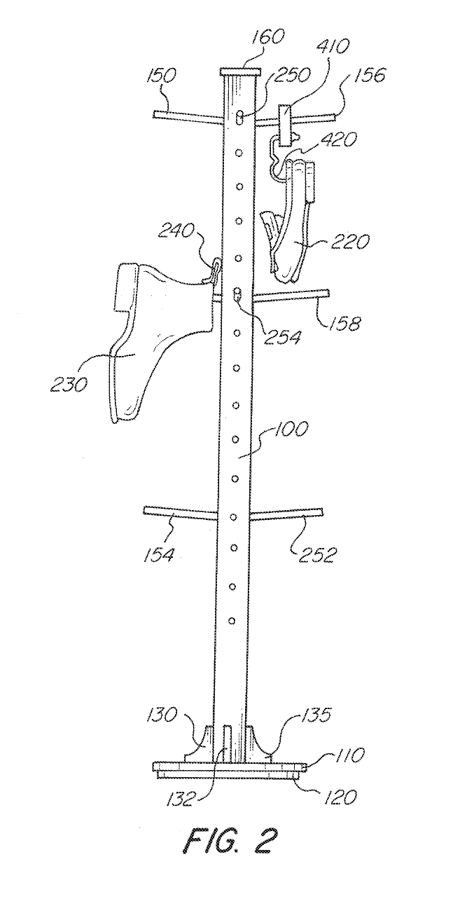

FIG. 2 shows the assembled storage rack 1000 of FIG. 1. In certain embodiments, there are ½ inch diameter holes bored into the longitudinal member. These holes are considered sockets. In certain embodiments, the storage rack 1000 may have a 59 inch height and the base 110/120 may be 13 inches in diameter. The longitudinal member 1000 may have a width of 2.5 inches. However, the storage rack 1000 may be adjusted to various heights and may have various diameters of both the base and longitudinal member.

FIG. 2 shows shoes 220 and 230 mounted on the storage rack. Also clip 240 is shown holding shoe 230. Clip 410 is shown with hanger 420, whereby shoe 220 is supported by a support peg.

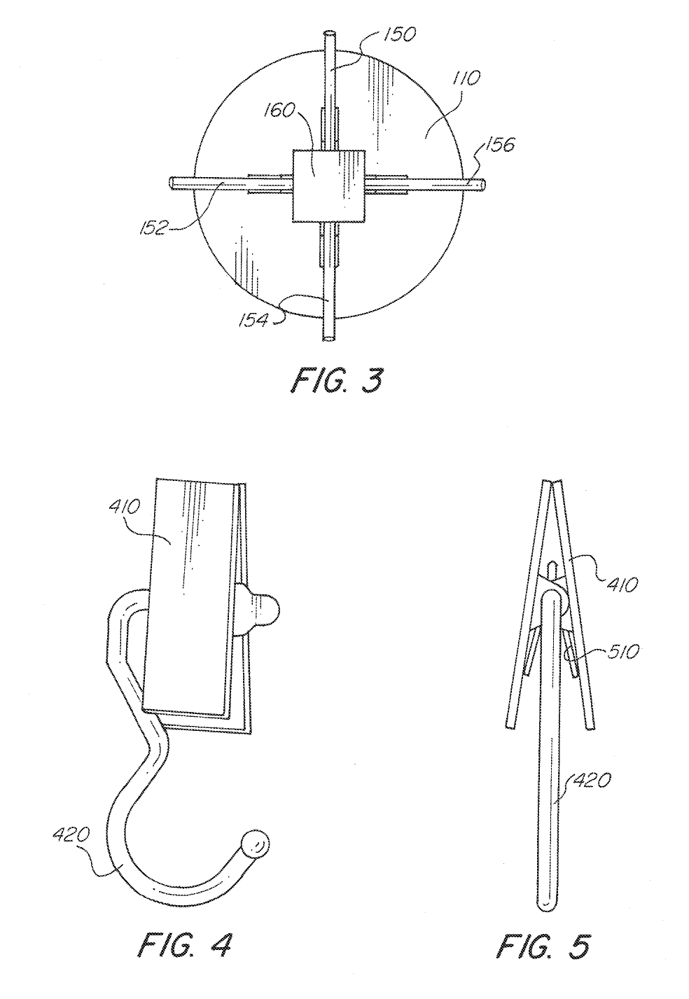

FIG. 3 shows a top view of the storage rack 1000 where it is shown that the base 110 is circular and that the pegs extend radially around the longitudinal member 100. The longitudinal member 100 is underneath cap 160.

FIG. 4 shows a boot clamp/hanger 410/420 which is used to support various boots and/or other footwear. The clip 410 may be attached to the plurality of support pegs when the top of the clip 410 that forms the V-shape is suspended vertically from a support peg. The hanger 420 hangs from the clip 410 and supports various types of footwear.

FIG. 5 shows a side view of the boot clamp/hanger 410/420. Here spring 510 is shown, so that the clip/hanger 410/420 can tightly attach to a support peg.

The storage rack 1000 may be made of various materials such as wood, iron, compressed wood, plastics and other such materials known in the art for use with storage racks 1000.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A storage rack comprising:
a rotatable base;
a longitudinal member extending upwardly from the base, the longitudinal member being substantially perpendicular to the base and having a plurality of sockets, and
a plurality of support pegs, the plurality of support pegs fitting within the plurality of sockets.

2. The storage rack of claim 1, wherein the base comprises an upper base element and lower base element, the upper base element being rotatable around the lower base element.

3. The storage rack of claim 1, wherein the base is configured as a lazy-Susan type rotating type mechanism.

4. The storage rack of claim 1, wherein the longitudinal member is rectangular and has four sides.

5. The storage rack of claim 1, wherein the longitudinal member is removable from the base and is securely mounted to a top of said base.

6. The rack of claim 1, further comprising at least one support element for securing the longitudinal member to the base.

7. The storage rack of claim 1, wherein the plurality of support pegs are of variable length.

8. The storage rack of claim 1, wherein the longitudinal member is of variable length and is adjustable.

9. The storage rack of claim 4, wherein the plurality of sockets are located on each of the four sides of the rectangular longitudinal member.

10. The storage rack of claim 9, wherein the plurality of sockets are located in a staggered pattern over the longitudinal member.

11. The storage rack of claim 1, wherein the rotatable base allow for the longitudinal member to rotate 360 degrees.

12. The storage rack of claim 1, wherein the plurality of support pegs support footwear.

13. The storage rack of claim 1, further comprising:
at least one clip; and
at least one hanger, the at least one clip attached to at least one of the plurality of support pegs,
wherein the at least one clip attaches to the at least one hanger for supporting an item.

14. The storage rack of claim 13, wherein the item is at least one of footwear, handbags, or hats.

15. The storage rack of claim 1, wherein the longitudinal member is hollow.

16. The storage rack of claim 15, further comprising a cap, the cap covering the top of the longitudinal member.

17. A method of manufacturing a storage rack, the method comprising the steps of:
providing a rotatable base;
providing a longitudinal member having a plurality of sockets;
providing at least one support element;
attaching the longitudinal member to the top of the base;
attaching the at least one support member to the top of the base and to the longitudinal member so that the longitudinal member is substantially perpendicular to the base and extends upwardly from the base; and
providing a plurality of support pegs.

18. The method of claim 17, further comprising inserting the plurality of support pegs into the plurality of sockets.

19. The method of claim 17, wherein the longitudinal member is rectangular and has four sides.

20. The method of claim 17, wherein the base comprises an upper base element and lower base element, the upper base element being rotatable around the lower base element.
